(19) United States
(12) Patent Application Publication
(10) Pub. No.: US 2012/0158227 A1
(43) Pub. Date: Jun. 21, 2012

(54) SYSTEM AND METHOD FOR MAXIMIZING A DRIVING RANGE IN AN ELECTRIC VEHICLE HAVING AN AUXILIARY POWER UNIT

(75) Inventors: Edward D. Tate, JR., Grand Blanc, MI (US); Steven A. Tarnowsky, West Bloomfield, MI (US)

(73) Assignee: GM GLOBAL TECHNOLOGY OPERATIONS LLC, Detroit, MI (US)

(21) Appl. No.: 12/974,044

(22) Filed: Dec. 21, 2010

(51) Int. Cl. B60L 15/20; B60L 11/18

(52) U.S. Cl. 701/22

(57) ABSTRACT

An electric vehicle maximizes an electric-only driving range. The vehicle includes a power source, an energy storage device, an auxiliary power unit (APU), and a controller. The power source propels the vehicle. The energy storage device supplies electricity to the power source. The APU supplies supplemental energy to the power source. The controller operates the vehicle in an electric-only driving mode to propel the vehicle and obtains a state of charge (SOC) of the energy storage device. The vehicle and at least one charging station are located. The controller determines a minimum required SOC of the energy storage device for the vehicle to reach at least one charging station. The controller activates the APU to operate the vehicle when the SOC of the energy storage device is below the minimum required SOC of the energy storage device for the vehicle to reach the location of at least one charging station.

### TECHNICAL FIELD

The present invention relates to a system and method for maximizing a driving range and electrification in an electric vehicle having an auxiliary power unit (APU).

### BACKGROUND

Vehicles employ various power sources for propulsion. Such power sources may include an internal combustion engine, one or more electric motors, and/or a fuel-cell.

Each of the power sources typically requires an energy storage device configured to receive and store energy, and to supply the stored energy to operate the power source. A specific amount of energy stored within the energy storage device generally operates the vehicle for a finite driving range. Such a driving range typically depends on a number of factors which may be related to the vehicle itself, as well as to road and weather conditions. Additionally, a vehicle operator's driving style may also influence the vehicle's available driving range.

### SUMMARY

A method is provided for maximizing an electric-only driving range of an electric vehicle including an energy storage device and auxiliary power unit (APU). The method includes operating the electric vehicle in an electric-only driving mode to selectively propel the electric vehicle. A state of charge (SOC) of the energy storage device is obtained. The geographical location of the electric vehicle and at least one charging station are determined. A minimum required SOC of the energy storage device for the electric vehicle to reach the geographic location of the at least one charging station is determined. The APU is activated to at least partially operate the electric vehicle when the obtained SOC of the energy storage device is determined to be below the minimum required SOC of the energy storage device for the electric vehicle to reach the geographic location of the at least one charging station.

An electric vehicle is configured to maximize an electric-only driving range. The electric vehicle includes a power source, an energy storage device, an APU, and a controller. The power source is configured to propel the electric vehicle. The energy storage device is configured to supply electricity to the power source. The APU is configured to selectively supply supplemental energy to the power source. The controller is configured for operating the electric vehicle in an electric-only driving mode to selectively propel the electric vehicle and obtaining a SOC of the energy storage device. The controller is also configured for geographically locating the electric vehicle and at least one charging station and for determining a minimum required SOC of the energy storage device for the electric vehicle to reach the geographic location of the at least one charging station. The controller activates the APU to at least partially operate the electric vehicle when the obtained SOC of the energy storage device is determined to be below the minimum required SOC of the energy storage device for the electric vehicle to reach the geographic location of the at least one charging station.

A controller adapted for use in an electric vehicle. The controller includes at least one memory location and an algorithm. The algorithm is adapted for determining when an energy storage device of the electric vehicle does not have a sufficient SOC to reach at least one charging location. The algorithm is adapted for obtaining the SOC of the energy storage device and geographically locating the electric vehicle and at least one charging station. The algorithm is further adapted to determine whether the SOC obtained from the energy storage device is sufficient for the electric vehicle to travel to the geographical location of the at least one charging station. The algorithm activates the APU to at least partially operate the electric vehicle when the obtained SOC of the energy storage device is determined to not be sufficient for the electric vehicle to travel to the geographical location of the at least one charging station. Likewise, the algorithm deactivates the APU when the obtained SOC of the energy storage device is determined to be sufficient for the electric vehicle to travel to the geographical location of the at least one charging station.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an electric vehicle having a system configured for maximizing an electric-only driving range;

FIG. 2 is an illustration of a visual display of the electric-only driving range including a plurality of charging stations and a required distance to reach the charging stations, for both line of sight and a route, all overlaid on a map;

FIG. 3 is an illustration of another visual display of the electric-only driving range displayed as an energy region, based on line of sight, and a plurality of the charging stations, all overlaid on the map;

FIG. 4 is an illustration of yet another visual display of the electric-only driving range displayed as an energy region, based on a route, and a plurality of the charging stations, all overlaid on the map; and

FIG. 5 is a flow chart illustrating a method for maximizing the electric-only driving range of the electric vehicle.

### DETAILED DESCRIPTION

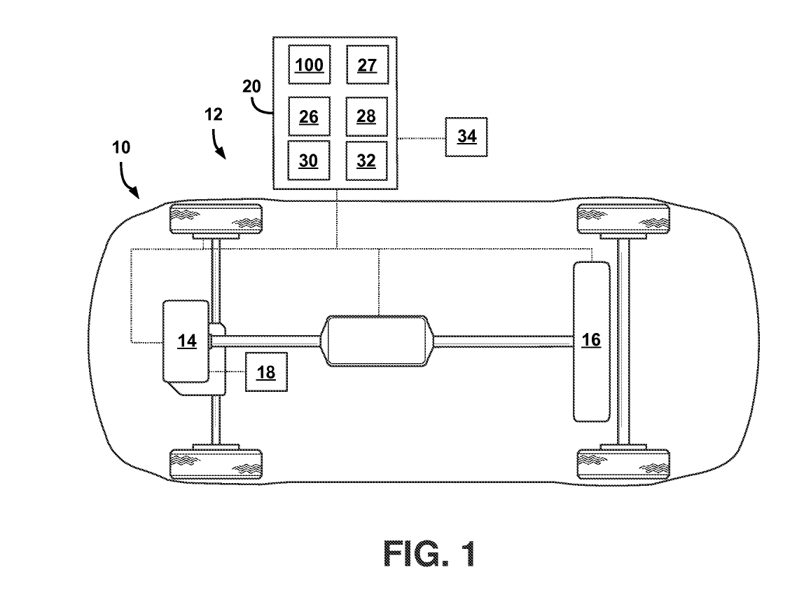

Referring to the drawings, wherein like reference numbers correspond to like or similar components throughout the several figures, FIG. 1 shows an electric vehicle 10 that is configured to maximize an electric-only driving range 22 or distance. The electric vehicle 10 may be a battery electric vehicle (BEV), an extended-range electric vehicle (EREV), a plug-in hybrid electric vehicle (PHEV), and the like.

The electric vehicle 10 includes a system 12 configured to maximize the electric-only driving range 22 of the electric vehicle 10. The system 12 includes a power source 14, an energy storage device 16, an auxiliary power unit (APU 18), and a controller 20. The power source 14 is configured to propel the electric vehicle 10. The energy storage device 16 is configured to supply energy to the power source 14 in the form of electricity. The energy storage device 16 may be an electric energy storage device 16, such as a rechargeable battery and the like.

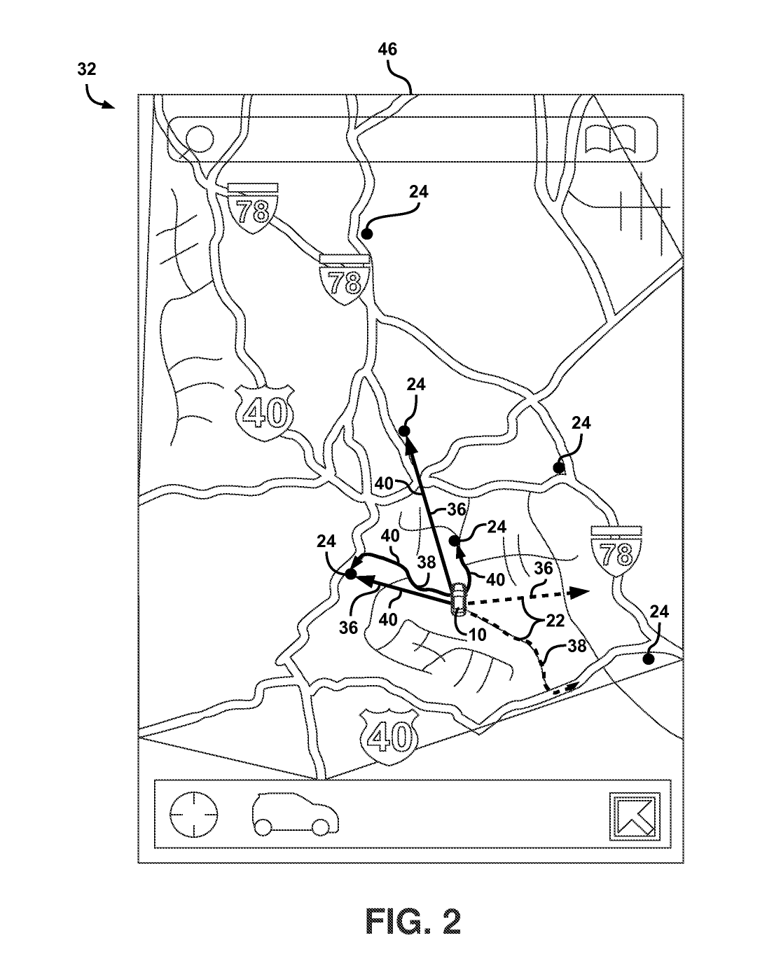

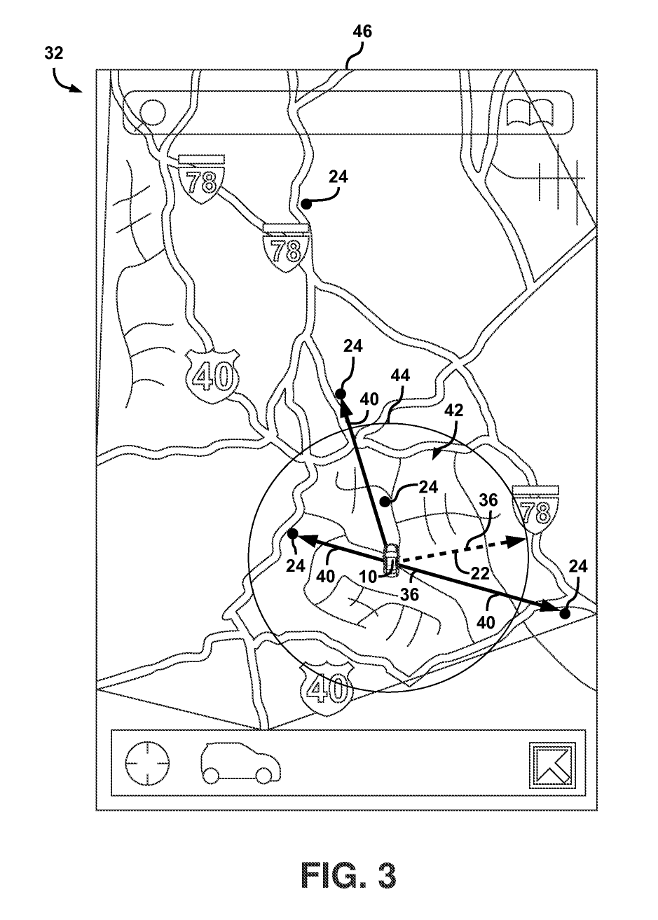

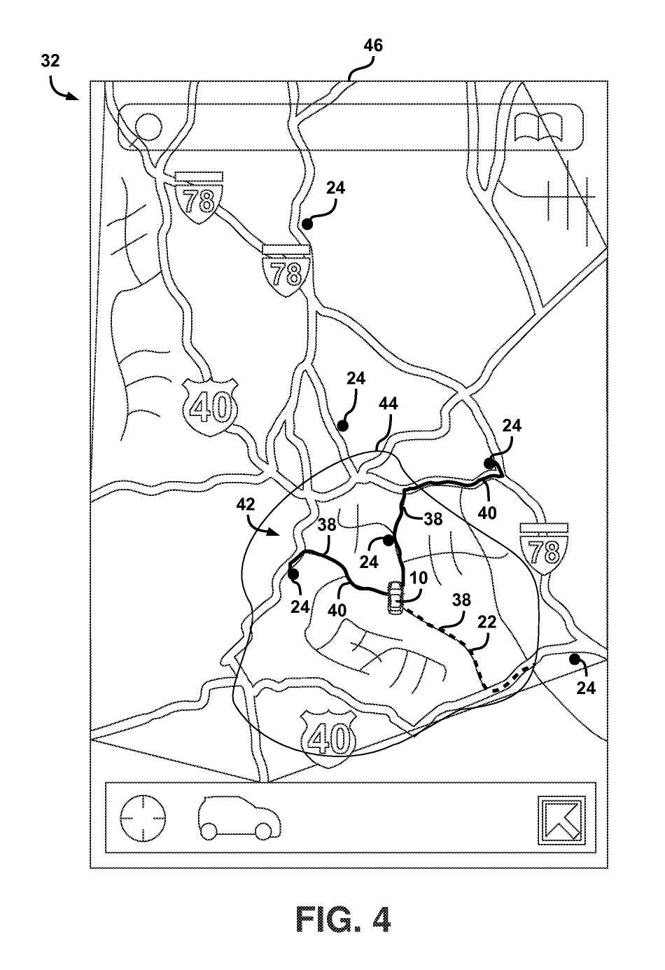

The APU 18 is activated by the controller 20 to supply supplemental energy to the power source 14 when a state of charge (SOC) of the energy storage device 16 is less than a minimum threshold. Likewise, the APU 18 may be deactivated by the controller 20 such that the electric vehicle 10 is operating in an electric-only driving mode. The APU 18 may be an internal combustion engine and the like. More specifically, the APU 18 is configured to engage and provide geographic range extension to the electric vehicle 10 when the SOC within the energy storage device 16 is depleted below the minimum threshold and the electric vehicle 10 is no longer within an electric-only driving range to reach at least one charging station 24 in the electric-only driving mode to recharge the energy storage device 16. The APU 18 is similarly configured to be disengaged from supplying supplemental energy to the power source 14 once the electric vehicle 10 is within the electric-only driving range 22 to reach at least one charging station 24. Therefore, the electric vehicle 10 is configured to operate in an electric-only driving mode, unless the electric-only driving range falls below a minimum threshold, at which time, the APU 18 is operated to engage and extend the driving range until which time the SOC of the energy storage device 16 is at least equal to the minimum threshold. The electric-only driving range 22 is the achievable distance the electric vehicle 10 can travel, based on the SOC within the energy storage device 16. The electric-only driving range 22 may be based on a line of sight 36, as illustrated in FIGS. 2 and 3, or based on a route 38, as illustrated in FIGS. 2 and 4.

The electric vehicle 10 is configured to be electrically charged at any of a plurality of charging stations 24, disposed in various geographical locations. The system 12 is configured to maximize the electric-only driving range 22 of the electric vehicle 10, as explained in more detail below. The system 12 determines the electric-only driving range stored within the energy storage device 16, i.e., energy (SOC). The system 12 also determines the required distance 40 for the electric vehicle 10 to reach at least one of the charging stations 24. When the remaining range of the energy storage device 16, i.e., the electric-only driving range 22, is determined to be below the minimum threshold, the APU 18 is activated such that the electric vehicle 10 can make it to at least one charging station 24 to charge the energy storage device 16 until the SOC within the energy storage device 16 is at least equal to the minimum threshold, at which time the APU 18 may be disengaged.

The controller 20 includes an algorithm 100 that provides a method of maximizing the electric-only driving range 22 of the electric vehicle 10, as explained in more detail below. The controller 20 may be configured as a digital computer generally comprising a microprocessor or central processing unit 26 (CPU), at least one memory device 28, a high-speed clock, analog-to-digital (A/D) and digital-to-analog (D/A) circuitry, and input/output circuitry and devices (I/O), as well as appropriate signal conditioning and buffer circuitry. The memory device 28 may include read only memory (ROM), random access memory (RAM), electrically-erasable programmable read only memory (EEPROM), and the like. It should be appreciated that more than one algorithm may also be included in the controller 20. The algorithms 100 resident in the controller 20, or accessible thereby, including the algorithm 100, as described below with reference to FIG. 1, can be stored and executed to provide the respective functionality. The algorithm is configured to automatically sample and archive a predetermined set of vehicle statistical information, e.g., energy consumption and distance traveled, charging stations 24 historically used by the electric vehicle 10, along with any other additional vehicle and/or environmental information. The sampling and archiving may be continuous or at predefined time intervals, as known to those of skill in the art.

In general, computing systems and/or devices, such as the CPU 26, may employ any of a number of computer operating systems and generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The controller 20 may optionally include a telematics unit 30 and/or a visual display 32. More specifically, in one embodiment, the controller 20 may communicate the statistical information to the telematics unit 30. The telematics unit 30 may use, by way of a non-limiting example, Bluetooth®, OnStar®, cell phone, or other suitable system, and the like. The telematics unit 30 may be configured to monitor, record, and transmit the statistical information pertaining to operation of electric vehicle 10 by the driver. The telematics unit 30 may also be configured to monitor internal communication, such as bus traffic between various distributed control modules of the controller 20 when the controller 20 is so configured. The statistical information may be transmitted from the memory location to a remote station, or be recorded and retained within the memory location for later access and processing. As described below, the electric vehicle 10 may be equipped with the visual display 32 that is adapted for displaying messages in the form of maps, text messages, e-mail, Hypertext Transfer Protocol (HTTP) links, and the like. The electric vehicle 10 may also be equipped with speakers 29 that are configured for providing audio messages and alerts.

Still referring to FIG. 1, the memory device 28 may include the RAM and ROM. The ROM may include the basic operating system of the telematics unit 30, and/or any other required data, communications protocols, and operating parameters which generally require permanent storage and rapid accessibility. The function of the RAM may include the manipulation and storage of vehicle performance values and other vehicle operating data as set forth below. The telematics unit 30 may also include a power supply circuit, a global positioning system (GPS) circuit, and an input/output (I/O) interface, as understood in the art.

Still referring to FIG. 1, the system may include one or more sensors 34 that are configured to collect vehicle performance values describing a driver's unique driving behavior. Data from sensors 34 may include, but is not limited to, information describing electric vehicle 10 speed history, Heating, Ventilation, and Air Conditioning (HVAC) usage history, location history of the electric vehicle 10, dates, times of day during which the electric vehicle 10 is operated, odometer readings, and the like. Data from the sensors 34 is used by the controller 20 to automatically calculate the ranges related to the SOC of the energy storage device 16. For example, controller 20 may generate or compile statistical information for transmission to the remote station, and/or for onboard storage and archiving in the memory location.

The statistical information is specific to the electric vehicle 10 and/or any driver(s) thereof over a period of time, and could also include, without being limited to: average fuel consumption or average vehicle speed over a specified time period; a cumulative density function chart describing the percentage of driving where less than a predetermined amount of fuel consumption was achieved over the specified time period; a probability density function chart showing a distribution of fuel consumption over the specified time period; a cumulative density function chart showing a percentage of driving where greater than a threshold distance was achieved over the specified time period; a probability density function chart showing distribution of driving distances over the specified time period; and city driving fuel consumption, which is defined as the average fuel consumption for all driving over a specified time period where the average vehicle speed over a given key operating cycle is below a specified vehicle speed.

The statistical information may further include: highway driving fuel consumption defined as the average fuel consumption for all driving over a specified time period where the average vehicle speed over a given key cycle was above a specified speed; city driving fuel consumption divided by vehicle label city fuel consumption; highway driver intensity factor defined as highway driving fuel consumption divided by the vehicle label city fuel consumption; composite driver intensity factor defined as average fuel consumption divided by the vehicle label composite fuel consumption; local electric utility rates; the current and/or projected average price of gasoline; etc.

The system 12 may be configured to predict the amount of electricity that would likely be consumed over a specified period of time and/or distance based on the statistical information described above. More specifically, the statistical information may be used by the controller 20 to determine a minimum SOC of the energy storage device 16 that is required to reach at least one of the charging stations 24.

Referring to FIGS. 1, 2, and 5, the algorithm 100 may be executed by the controller 20 and includes steps 112-126. At step 110 of the algorithm, the electric vehicle 10 is operated in an electric-only driving mode to selectively propel the electric vehicle 10. In the electric-only driving mode, the APU 18 is deactivated and is not operating the electric vehicle 10.

At step 112, the geographical location of at least one charging station 24 may be stored in the memory device 28. The geographical locations may include coordinates, i.e., latitude and longitude. It should be appreciated that the geographical locations may be identified and stored using any other method of location and identification, as known to those of skill in the art. The geographical location may include at least one charging station 24 that was previously used in the past to charge the electric vehicle 10.

The SOC of the energy storage device 16 is obtained at step 114. The actual SOC of the energy storage device 16 may be obtained by the controller 20 and/or direct measurement, and the like. In one embodiment, the actual SOC of the energy storage device 16 may be converted, e.g., via the controller 20, to the electric-only driving range 22 the electric vehicle 10 can travel before the SOC is below the minimum threshold, and therefore no longer sufficient to propel the electric vehicle 10 in the electric-only driving mode. More specifically, as described above, the determination of the electric-only driving range 22 may be based off of the statistical information, including, but not limited to, historical driving. Additional other factors, such as road grades, environmental temperature, traffic conditions, and the like, may also be used in determining the required minimum SOC of the energy storage device 16, as known to those of skill in the art. Referring to FIG. 2, the electric-only driving range 22 may be displayed to overlap a map 46 on the visual display 32 based on the line of sight 36 and/or route 38. It should be appreciated however, that an audio message pertaining to the electric-only driving range 22 may be transmitted through the speakers 29. The audio message may be in lieu of the visual display 32 or as a supplement to the visual display 32 to as to limit any unnecessary distraction to the driver.

At step 116, the geographical location of the electric vehicle 10 is determined. The geographical location may be determined using a location system, such as, a GPS system, a cell location system, a radio location system, and/or any other location system, as known to those of skill in the art.

At step 118, the geographical location of at least one charging station 24 is geographically located. More specifically, the geographical location of the charging stations 24 may be retrieved from the memory device 28 or may be accessed remotely, via the telematics unit 30 or any other similar device. The system 12 may be configured such that only the charging stations 24 that are within a predefined geographic area, range, and/or route are retrieved.

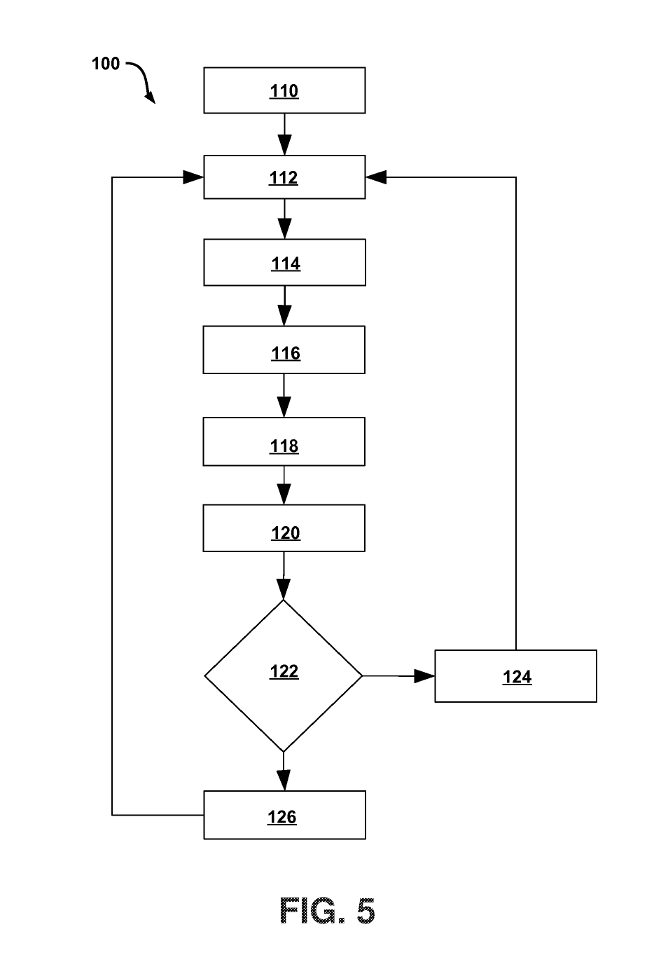

At step 120, a determination is made by the controller 20 as to a minimum required SOC, i.e., the minimum threshold, of the energy storage device 16 such that the electric vehicle 10 can reach at least one of the charging stations 24 when operating in the electric-only driving mode. In order to determine the minimum required SOC, a required distance 40 between the electric vehicle 10 and at least one of the charging stations 24 may be determined. More specifically, as described above, the minimum required SOC for the electric vehicle 10 to traverse the required distance 40 may be based off of the statistical information, including, but not limited to, historical driving. The distance, i.e., the electric-only driving range 22 and/or the required distance 40, may be calculated based on the line of sight 36, as illustrated in FIG. 4, and/or based on the route 38, as illustrated in FIG. 5.

At step 122, a determination is made as to whether the SOC stored within the energy storage device 16 is sufficient for the electric vehicle 10 to travel to at least one of the charging stations 24. The minimum required SOC of the energy storage device 16, determined at step 120, is compared with the actual SOC of the energy storage device 16, obtained at step 114. Alternatively, the required distance 40 is compared with the electric-only driving range 22 achievable by the electric vehicle 10. If the actual SOC of the energy storage device 16 is determined to be below the minimum required SOC of the energy storage device 16, or the electric-only driving range 22 is determined to be less than the required distance 40, the APU 18 is activated at step 124 to at least partially operate the electric vehicle 10 such that the electric vehicle 10 is capable of reaching at least one of the charging stations 24. Alternatively, if the actual SOC of the energy storage device 16 is determined to be at least equal to the minimum required SOC of the energy storage device 16, or the electric-only driving range 22 is determined to be at least equal to the required distance 40, the APU 18 is deactivated at step 126, i.e., turned off or otherwise remains inactivated, since the electric vehicle 10 is presumed to have a sufficient SOC to reach at least one of the charging stations 24 in the electric-only driving mode.

In another embodiment, with reference to FIGS. 1 and 3-5, the determination at step 116 of whether the energy storage device 16 has a sufficient SOC to reach at least one charging station 24 is based on whether or not at least one charging station 24 is disposed within an energy region 42 that surrounds the electric vehicle 10. The energy region 42 may be defined as a geographic region that includes a perimeter 44 that at least partially surrounds the electric vehicle 10, as illustrated in FIGS. 3 and 4. More specifically, the electric-only driving range 22 is defined as the distance between the electric vehicle 10 and the perimeter 44 that the electric vehicle 10 can travel, based on the actual SOC of the energy storage device 16. The energy storage device 16 is considered to have a sufficient SOC to reach at least one charging station 24 if at least one charging station 24 is located within the perimeter 44 of the energy region 42. The distance of the electric-only driving range 22 may be based on line of sight 36, as shown in FIG. 3, and/or based on a route 38, as shown in FIG. 4.

The energy region 42 surrounding the electric vehicle 10 is a function of the SOC of the energy storage device 16, which may be determined by the controller 20. The APU 18 is activated at step 122 to at least partially operate the electric vehicle 10 when all of the charging stations 24 are outside of the energy region 42. Likewise, the APU 18 is deactivated at step 122 when at least one charging station 24 is located within the energy region 42. The energy region 42 surrounding the electric vehicle 10 and the geographical location of the electric vehicle 10 and each charging station 24 may be displayed to overlap a map 46 on the visual display 32.

While the best modes for carrying out the invention have been described in detail, those familiar with the art to which this invention relates will recognize various alternative designs and embodiments for practicing the invention within the scope of the appended claims.

1. A method of maximizing an electric-only driving range of an electric vehicle including an energy storage device and auxiliary power unit (APU), the method comprising:
operating the electric vehicle in an electric-only driving mode to selectively propel the electric vehicle;
obtaining a state of charge (SOC) of the energy storage device;
geographically locating the electric vehicle;
geographically locating at least one charging station;
determining a minimum required SOC of the energy storage device for the electric vehicle to reach the geographic location of the at least one charging station; and
activating the APU to at least partially operate the electric vehicle when the obtained SOC of the energy storage device is determined to be below the minimum required SOC of the energy storage device for the electric vehicle to reach the geographic location of the at least one charging station.

2. A method, as set forth in claim 1, further comprising deactivating the APU when the obtained SOC of the energy storage device is determined to be at least equal to the minimum required SOC of the energy storage device for the electric vehicle to reach the geographic location of the at least one charging station.

3. A method, as set forth in claim 1, further comprising calculating a distance between the electric vehicle and the at least one charging station;
wherein determining a minimum SOC of the energy storage device is further defined as determining a minimum required SOC of the energy storage device for the electric vehicle to traverse the distance to the at least one charging station in the electric-only driving mode; and
wherein activating the APU is further defined as activating the APU to at least partially operate the electric vehicle when the obtained SOC of the energy storage device is determined to be below the minimum required SOC of the energy storage device for the electric vehicle to traverse the distance to the at least one charging station.

4. A method, as set forth in claim 3, further comprising deactivating the APU when the obtained SOC of the energy storage device is determined to be at least equal to the minimum required SOC of the energy storage device for the electric vehicle to traverse the distance to the at least one charging station.

5. A method, as set forth in claim 3, wherein calculating a distance is further defined as calculating a distance between the location of the at least one charging station and the electric vehicle based on a line of sight.

6. A method, as set forth in claim 3, wherein calculating a distance is further defined as calculating a distance between the location of the at least one charging station and the electric vehicle based on a route.

7. A method, as set forth in claim 1, wherein determining a minimum required SOC is further defined as determining a minimum required SOC of the electric vehicle to reach the at least one charging station, as a function of historical driving.

8. A method, as set forth in claim 1, further comprising recording in a memory location, at least one charging station previously used to charge the electric vehicle; and
wherein geographically locating the at least one charging station is further defined as retrieving from the memory location, at least one charging station previously used to charge the electric vehicle.

9. A method, as set forth in claim 1, further comprising determining an energy region including a perimeter that surrounds the electric vehicle;
wherein the energy region is a function of the SOC of the energy storage device;
wherein activating the APU is further defined as activating the APU to at least partially operate the vehicle when any of the at least one charging stations are outside of the energy region such that the obtained SOC of the electric vehicle is determined to be less than the minimum required SOC of the energy storage device to reach any of the at least one charging stations.

10. A method, as set forth in claim 9, further comprising deactivating the APU when at least one charging station is inside of the energy region such that the obtained SOC of the electric vehicle is determined to be at least equal to the minimum required SOC of the energy storage device to reach the at least one charging station.

11. A method, as set forth in claim 9, further comprising displaying the energy region with the perimeter surrounding the electric vehicle as a function of the SOC of the energy storage device on a visual display.

12. A method, as set forth in claim 1, further comprising displaying the geographical location of each of the vehicle and the at least one charging station on a visual display.

13. A method, as set forth in claim 1, further comprising transmitting an audio message pertaining to the geographical location of each of the vehicle and the at least one charging station through a speaker.

14. A method, as set forth in claim 1, wherein the energy storage device is a battery.

15. An electric vehicle configured to maximize an electric-only driving range, the electric vehicle comprising:
a power source configured to propel the electric vehicle;
an energy storage device configured to supply electricity to the power source;
an auxiliary power unit (APU) configured to selectively supply supplemental energy to the power source; and
a controller configured for:
operating the electric vehicle in an electric-only driving mode to selectively propel the electric vehicle;
obtaining a state of charge (SOC) of the energy storage device;
geographically locating the electric vehicle;
geographically locating at least one charging station;
determining a minimum required SOC of the energy storage device for the electric vehicle to reach the geographic location of the at least one charging station; and
activating the APU to at least partially operate the electric vehicle when the obtained SOC of the energy storage device is determined to be below the minimum required SOC of the energy storage device for the electric vehicle to reach the geographic location of the at least one charging station.

16. An electric vehicle, as set forth in claim 15, further comprising a visual display configured for displaying the geographical location of each of the vehicle and the at least one charging station.

17. An electric vehicle, as set forth in claim 15, wherein the energy storage device is a battery.

18. An electric vehicle, as set forth in claim 15, wherein the APU is an internal combustion engine.

19. A controller adapted for use in an electric vehicle, the controller comprising:
at least one memory location; and
an algorithm adapted for determining when an energy storage device of the electric vehicle does not have a sufficient state of charge (SOC) to reach at least one charging location;
wherein the algorithm is adapted for:
obtaining the SOC of the energy storage device;
geographically locating the electric vehicle;
geographically locating at least one charging station;
determining whether the SOC obtained from the energy storage device is sufficient for the electric vehicle to travel to the geographical location of the at least one charging station;
activating the APU to at least partially operate the electric vehicle when the obtained SOC of the energy storage device is determined to not be sufficient for the electric vehicle to travel to the geographical location of the at least one charging station; and
deactivating the APU when the obtained SOC of the energy storage device is determined to be sufficient for the electric vehicle to travel to the geographical location of the at least one charging station.

20. A controller, as set forth in claim 19, wherein the algorithm is further adapted for recording in the memory location, at least one charging station previously used to charge the electric vehicle; and
wherein geographically locating the at least one charging station is further defined as retrieving from the memory location, at least one charging station previously used to charge the electric vehicle.
